(19) United States
(12) Patent Application Publication
(10) Pub. No.: US 2004/0215489 A1
(43) Pub. Date: Oct. 28, 2004

(54) Pharmaceutical patient information system

(76) Inventors: Klaus Abraham-Fuchs, Erlangen (DE); Johannes Bieger, Munchen (DE); Uwe Eisermann, Erlangen (DE); Arne Hengerer, Erlangen (DE); Eva Rumpel, Erlangen (DE); Kai-Uwe Schmidt, Erlangen (DE); Daniel Tietze, Spardorf (DE)

Correspondence Address: HARNESS, DICKEY & PIERCE, P.L.C., P.O.BOX 8910, RESTON, VA, 20195, US

(21) Appl. No.: 10/483,959

(22) PCT Filed: Jul. 4, 2002
(86) PCT No.: PCT/DE02/02452

(30) Foreign Application Priority Data
Jul. 17, 2001 (DE) 101 34 822.3

(51) Int. Cl. G06F 17/60

(52) U.S. Cl. 705/2

(57) ABSTRACT

A patient information system for the provision of individual-specific information on the effects and risks of a medicament includes an expert system, in which relevant data on the medicament, for example, compositions, application area, contra-indications, mode of action, risks and side-effects are stored. The expert system is embodied such that, on a user inquiry about a particular medicament by inputting particular personal status data about the user, an individual user information reply, which matches the personal status data including the education and the knowledge state of the user—(a personalized enclosure) is generated including all relevant data, and excluding data on the medicament which need not be introduced according to the special requirements of the user.

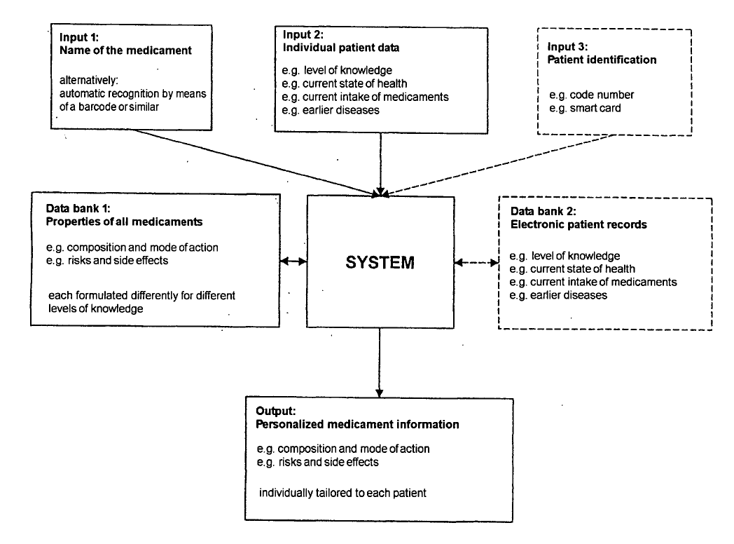

This application is the national phase under 35 U.S.C. § 371 of PCT International Application No. PCT/DE02/02452 which has an International filing date of Jul. 4, 2002, which designated the United States of America and which claims priority on German Patent Application number DE 101 34 822.3 filed Jul. 17, 2001, the entire contents of which are hereby incorporated herein by reference.

### FIELD OF THE INVENTION

The invention generally relates to a patient information system, and more specifically relates to one for generating individual-specific information on the effects and risks of a medicament.

### BACKGROUND OF THE INVENTION

Every medicament sold in a drugstore is accompanied by an instruction leaflet which provides the purchaser (patient) with information on, for example, the composition, areas of application, contraindications, mode of action, risks and side effects of the medicament. The content of the instruction leaflet is formulated in such a way that it complies with all the legal regulations. However, as such, a great deal of information is included which is for the most part completely irrelevant to the individual patient and also for the most part unintelligible to the patient. Accordingly, despite constant advice given through TV advertising, patients do not even read such instruction leaflets.

Just as futile are the constant exhortations to consult a physician or pharmacist if there are any queries about the instruction leaflet. Taking into account the possible correlations with other medications, modern medicaments also have so many side effects that the physician or pharmacist may not even be able to provide concrete information for all medicaments. This is especially true if it is not possible to take into consideration the particular health status and circumstances of the patient.

In addition to possible side effects being set out, for legal reasons, in an exhaustive manner which can completely confuse many patients, another factor is that the composition and the mode of action are often either explained too generally or are too difficult to understand, depending on the experience and level of education of the patient. Risks and side effects depend crucially on the general state of health of the patient and on his medical history. Thus, there may be so many peripheral factors at play that, quite apart from the fact that the patient in such cases does not even look at the instructions, there is not enough space for them even on an instruction leaflet of several pages in length.

In WO 99/45490, a medication monitoring system has already been proposed in which the patient, in conjunction with an expert system including the stored data on the patient at the physician and the stored data on the medicaments at a pharmacist, establishes interactions between a newly prescribed medicament and other medicaments taken by the patient, in order to deliver a warning in case of any contraindications. However, this is a real differentiation aid configured such that information is output on whether a certain medicament is compatible with the other medicaments taken by the patient or with his medical history. This, however, is not an instruction leaflet in which the patient is given comprehensive advice on the different modes of action of a medicament. Such information is completely absent from the decision-making aid according to WO 99/45490.

Accordingly, the same applies also to a system described in DE 695 07 691 T1 which likewise concerns a medical decision-making aid in which, for a given medicament, further additional information on other medicaments and diseases is assessed and weighted via a logic processing unit in order to generate a direct recommendation on administration of this specific medicament. This does not involve providing a patient with an instruction leaflet, as is provided for a medicament in accordance with German law, wherein the instruction leaflet should not contain too much information not of direct interest.

DE 198 42 046 A1 also relates to a system for providing a patient with specific information on a concrete problem, independently of the advice given by the physician. An electronically generated instruction leaflet for a medicament, free of superfluous information, does not however concern the use of the medicament for a specific problem, but the properties of the medicament in respect of all possible cases of use and all possible problems which may occur. In an instruction leaflet, it is not a matter of whether a specific medicament is especially suitable for a very specific problem, but instead involves indicating all possible relevant data with respect to a wide variety of problems. It is therefore not a matter of what particular disease a patient has at a given time and of providing a decision-making aid on whether a specific medicament relates to this disease.

### SUMMARY OF THE INVENTION

An object of an embodiment of the invention is to make available a patient information system for generating individual-specific information on the action and risks of a medicament. The information may be tailored specifically at the particular patient and/or his level of education and his medical history. As such, only a small number of directions and recommendations related specifically to this patient, and therefore actually taken notice of by the patient, are given.

To achieve an object, a patient information system includes, according to an embodiment of the invention, an expert system in which relevant data on the medicament, for example composition, area of application, contraindications, mode of action, risks and side effects, are stored. The expert system may be configured in such a way that, when a user inquiry is made concerning a particular medicament and including certain data relating to the personal status of the user, individual user information (a personalized instruction leaflet) based on the personal status data—including the educational background and level of knowledge of the user—is generated. This may include all relevant data and may exclude only those data on the medicament which are not pertinent to the particular user making the inquiry. The expert system may have access to electronic patient records, stored centrally or decentralized, and may take from these records some of the personal status data relating to the patient.

The expert system may have access to electronic patient records stored centrally or decentralized, so that, after it has been enabled via a suitable identification system for protecting access to stored personal data, and without further inputs except perhaps the name of the physician in question, a personalized instruction leaflet may be generated. This leaflet, because it may be tailored directly to the personal circumstances of the person making the inquiry, can be kept relatively short and accordingly may therefore be more likely to receive the proper attention. The personal status data may thus include, for example, the age, existing diseases, current wellbeing, and current medicament history and medical history of the person making the inquiry.

An example of the simplification of the instruction leaflet for a medicament, with the aid of the patient information device according to an embodiment of the invention, may for example be the omission of information on a medicament having certain problems specific to women, such as side effects in pregnancy or the like, in cases where the user making the inquiry is a man. A man is not at all interested in such information on side effects of the medicament in pregnant women or on any other effects particular to females. Thus, the instruction leaflet, by omission of this information, can be made shorter and simplified from the outset.

The person may also indicate that he is not a diabetic, for example, or the expert system may recognize from the personal patient records that the patient is not a diabetic. As such, the instruction leaflet also does not need to include the side effects concerning diabetics, etc.

The above underlines a significant difference between the patient information system of an embodiment of the present invention and the decision-making aids discussed by way of introduction in the background. If a patient who indicates only that he has diabetes were inquiring about a medicament using the systems of the background, this system would only answer whether the medicament is suitable for diabetics or not. The information system according to an embodiment of the invention, however, would, from all the available data on the medicament, print out all the data, including those for diabetics, since, for lack of the necessary personal data, closer restriction of the instruction leaflet has not been input. The user in this case would therefore receive the complete instruction leaflet as is hitherto always enclosed with such medicaments.

The function of an expert system of one embodiment, namely that of using the input status data of the user as filter criteria to select those data on the medicament which are relevant to this patient, can be greatly facilitated by virtue of the fact that the patient information may be stored according to a hierarchical structure (in contrast to a continuous text representation as on an instruction leaflet). An example of such a hierarchically structured memory would be where the information is ordered in information categories, for example “Type of side effect” (for example stomach pain, tiredness), “Typical incidence of a side effect”, “Personal circle in which the side effect occurs” (children, adults, women, men), “Other factors which may cause the side effect” (other underlying disease, such as diabetes or allergies), and where the elements of these information categories (for example specific side effects such as stomach pain, tiredness) are stored in a matrix structure or otherwise branched structure. As such, for example, in the case where a restricted personal circle is input, only the side effects relevant to this personal circle are automatically selected and included in the subsequent evaluation.

Instead of direct input of personal status data, for example age, existing diseases, current wellbeing, and current medicament history and also medical history of the person making the inquiry, a refinement of an embodiment of the invention proposes that the expert system has access to electronic patient records stored centrally or decentralized. As such, after it has been enabled via a suitable identification system for protecting access to stored personal data, and without further inputs, except of course the name of the physician in question, a personalized instruction leaflet is generated which, because it is tailored directly to the personal circumstances of the person making the inquiry, can be kept relatively short and accordingly also ensures that it receives the proper attention.

The patient information system according to an embodiment of the invention, which for example can be freely accessible on the Internet, can additionally be coupled to data banks of pharmaceuticals manufacturers and other already existing large data banks in order to gain the greatest possible amount of information on the modes of action and contraindications of the respective medicaments. As such, an optimal comparison is possible of the specific type, use and compatibility of a medicament for the particular patient making the inquiry.

The patient information system according to an embodiment of the invention can be used in various ways depending on where the use is to take place.

For use at home in an embodiment, the Internet may be used. The patient enters the required input data into a form on a web page. For this purpose, he needs a way to access to the Internet (terminal), for example a PC, a web pad, a set top box, etc. The expert system can then be set up on the web server and, from the data input by the patient, it may generate a personalized instruction leaflet. This output may then be transmitted to the terminal used by the patient and may be displayed on the screen, stored as a file, and/or printed out by a printer.

Another very useful way of using the patient information system according to an embodiment of the invention is to provide inquiry terminals, preferably in doctors' practices or drugstores. In this case, the inquiry terminal can be enabled, for example, via a health insurance smart card or a machine-readable identity card. These terminals too may be connected via a data line to a server on which the expert system runs, and the responses from the expert system may again be output on the terminal, either on screen or on paper. In addition to the identification systems already mentioned, the inquiry terminal can in this case also be provided with barcode readers or the like for automatic recognition of a medicament on the basis of its packaging.

### BRIEF DESCRIPTION OF THE DRAWINGS

Further advantages, features and details of the invention will become evident from the description of illustrated embodiments given hereinbelow and the accompanying drawing, which is given by way of illustration only and thus is not limitative of the present invention, wherein:

The drawing shows a flow chart of the system according to an embodiment of the invention for generating a personalized instruction leaflet.

### DETAILED DESCRIPTION OF THE PREFERRED EMBODIMENTS

The center of the facility according to an embodiment of the invention is an expert system which is designated in the drawing by the word SYSTEM and which communicates with an Input 1 for inputting the particular medicament. The inputting can alternatively also be done in other ways, such as by automatic recognition by a barcode reader for example, etc.

In addition to the name of the medicament (“Input 1”), the patient offers to the SYSTEM, information on his level of knowledge (for example “medical layperson”, “physician”, or suitable intermediate stages) and his medical condition (illnesses, wellbeing, current medicament intake) and his medical history (for example earlier diseases, intolerances, predispositions) with (“Input 2”).

If the patient uses the SYSTEM repeatedly, some or all of this information on the individual patient can also be stored (“Data bank 2”). Thus, this information can be retrieved in the event of subsequent inquiries to the system. It is likewise possible for the expert system to set up a connection to a centrally stored “electronic patient record” of the patient (at a hospital, with the family physician, etc.) and exploits the information stored there for improved individualization of the instruction leaflet.

On the basis of these inputs 1 and 2, the expert system, which is coupled to a data bank 1 on the properties of the medicament, can generate personalized pharmaceutical information concerning the compositions and modes of action, risks and side effects of the particular medicament, and can do so in a manner individually tailored to the specific patient and his state of health. All the usual instruction leaflet details which are not relevant to the person making the inquiry are simply not printed at all. Thus, the confusing, almost unreadable and unintelligible instruction leaflets of previous medicament packages are completely redundant. The patient receives only the information which is important to him. Thus, it is then very much more probable that this information will attract the patient's attention and therefore be heeded.

Alternatively, an Input 3 concerning the patient's identification can also be provided, for example involving a code number or a smart card, a machine-readable identity card, etc. This Input 3 is particularly important if the expert system according to an embodiment of the invention is connected not just to the data bank 1 on the properties of all medicaments, but also to electronic patient records, as are managed by service providers, hospitals, the general practitioner, etc. From these records, the expert system can itself procure the information usually input manually via Input 2 by the person making the inquiry.

Further, in cases of multiple diseases or many previous illnesses and the intake of a wide variety of medicaments, this system of access to an electronic patient record is of course much more reliable than inputting by the patient himself. Experience has shown that patients in such cases often forget one or other disease or one or other medicament, or do not know enough about them. Thus, it is then of course not possible to make an optimal comparison of the medicament information in data bank 1 with the individual patient data. Accordingly, it is also not possible to generate an optimally personalized instruction leaflet.

In addition to data bank 1 concerning the properties of all medicaments, a series of other special data banks can of course also be incorporated in the system. These can include, for example, a central data bank of a third party, for example of the publishers of the “Rote Liste”, downloads from or links to distributed data banks of pharmaceuticals manufacturers, and evaluation of advice on medication in “medical guidelines” data banks. Finally, data sources concerning recent clinical and scientific studies on the efficacy, etc., of medicaments (scientific periodicals, etc.) can be connected up to the expert system. Further, the expert system may, if appropriate, also compare the information from competing data sources.

It is particularly advantageous for the personalized instruction leaflet also to bear the name and possibly the address of the user for whom it has been generated, so that it is immediately obvious that the details appearing thereon have been generated for a quite specific individual. Further, another party will recognize immediately that this instruction leaflet may not be suitable for him at all. Therefore, such an indication ought preferably also to be printed on the instruction leaflet, since complications regarding liability could otherwise arise.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A patient information system for generating individual user-specific information regarding a medicament, comprising:
an expert system, adapted to retrieve data relevant to the medicament, said expert system being configured such that, when an inquiry including data relating to a status of an individual user is received for the medicament, individual user-specific information based on the inquiry is generated, the individual user-specific information including relevant data and excluding data, based upon the inquiry, on the medicament which are not pertinent to the individual user, the expert system having access to stored information potentially data relating to a status of the individual user.

2. The patient information system as claimed in claim 1, wherein the relevant data are stored in hierarchical order.

3. The patient information system as claimed in claim 1, wherein the expert system is coupled to at least one data banks containing medicament information from suppliers.

4. The patient information system as claimed in claim 1, wherein the expert system is accessible on the Internet.

5. The patient information system as claimed in claim 1, further comprising:
at least one inquiry terminal, adapted to provide an inquiry.

6. The patient information system as claimed in claim 5, wherein the inquiry terminal includes a barcode readers or the like for automatic recognition of a medicament via its packaging.

7. The patient information system as claimed in claim 1, further comprising an identification systems for protecting access to stored data personal to an individual user.

8. The patient information system as claimed in claim 5, wherein the terminal is enabled via machine-readable card.

9. The patient information system as claimed in claim 1, wherein the expert system is adapted to generate differentiated information depending on input qualifications of the individual user making the inquiry.

10. The patient information system as claimed in claim 1, wherein the input data relating to the status of the user are stored at a time of first use and is recallable from the memory upon a subsequent use.

11. The patient information system as claimed in claim 1, wherein
the data relating to the status of the user include potential medicament side effects observed by the user, and wherein the user is adapted to receive advice on the medicaments potentially causing such side effects.

12. The patient information system as claimed in claim 1, wherein the data relating to the status of the user include information on incorrect intake of a medicament, and wherein the user is adapted to receives advice concerning at least one of possible consequences of the incorrect intake and possible corrective measures.

13. The patient information system as claimed in claim 1, wherein a personalized instruction leaflet is adapted to carry personal data of the individual user for whom it has been generated.

14. The patient information system as claimed in claim 1, wherein the relevant data on the medicament includes at least one of composition, area of application, contraindications, mode of action, risks and side effects.

15. The patient information system as claimed in claim 1, wherein the individual user-specific information includes a personalized instruction leaflet.

16. The patient information system as claimed in claim 1, wherein the status data includes at least one of educational background and level of knowledge of the user.

17. The patient information system as claimed in claim 1, wherein the expert system has access to electronic patient records, stored at least one of centrally and de-centrally, and is adapted to obtain from these records, at least some of the status data relating to the individual user.

18. The patient information system as claimed in claim 1, wherein individual user-specific information is generated on at least one of the effects and risks of the medicament.

19. The patient information system as claimed in claim 3, wherein the other suppliers include pharmaceuticals manufacturers.

20. The patient information system as claimed in claim 1, further comprising:
at least one inquiry terminal, adapted to provide an inquiry, located proximate to a doctor office.

21. The patient information system as claimed in claim 1, further comprising:
at least one inquiry terminal, adapted to provide an inquiry, located proximate to a pharmacy.

22. The patient information system as claimed in claim 5, wherein the inquiry terminal includes means for automatic recognition of a medicament via its packaging.

23. A method for generating individual user-specific information regarding a medicament, comprising:
receiving an inquiry, including data relating to a status of an individual user making the inquiry, for the medicament;
retrieving data relevant to the medicament; and
generating individual user-specific information based on the inquiry, the individual user-specific information including relevant data retrieved and excluding retrieved data on the medicament which are, based upon the received inquiry, determined not to be pertinent to the individual user.

24. The method of claim 23, wherein information potentially includes data relating to a status of the individual user is retrievable.

25. A system for generating individual user-specific information regarding a medicament, comprising:
means for receiving an inquiry, including data relating to a status of an individual user making the inquiry, for the medicament;
means for retrieving data relevant to the medicament; and
means for generating individual user-specific information based on the inquiry, the individual user-specific information including relevant data retrieved and excluding retrieved data on the medicament which are, based upon the received inquiry, determined not to be pertinent to the individual user.

26. The method of claim 25, wherein information potentially includes data relating to a status of the individual user is retrievable.
